(19) United States
(12) Patent Application Publication
(10) Pub. No.: US 2026/0307464 A1
(43) Pub. Date: Oct. 8, 2026

(54) VEHICLE THERMAL MANAGEMENT SYSTEM

(71) Applicants: HYUNDAI MOTOR COMPANY, Seoul (KR); KIA CORPORATION, Seoul (KR)

(72) Inventors: Qingdong Hou, Yantai (CN); Tae Hun Jung, Hwaseong-si (KR); Xiaorui Zhai, Yantai (CN)

(73) Assignees: HYUNDAI MOTOR COMPANY, Seoul (KR); KIA CORPORATION, Seoul (KR)

(21) Appl. No.: 19/305,527

(22) Filed: Aug. 20, 2025

(30) Foreign Application Priority Data
Apr. 3, 2025 (CN) 202510417378.X

(51) Int. Cl. B60H 1/32; B60H 1/00; B60H 1/22

(52) U.S. Cl. CPC B60H 1/32281; B60H 1/00278; B60H 1/00571; B60H 1/00807; B60H 1/00885; B60H 1/3229; B60H 2001/224

(57) ABSTRACT

A vehicle thermal management system includes: a first coolant circuit including a range extender, a thermostat, a first pump, a heater, a heater core, and a second pump, which are connected through a first coolant line; and a second coolant circuit including a battery, a heat exchanger, and a third pump, which are connected through a second coolant line. In particular, the first coolant circuit further includes a first coolant bypass line having one end connected to the first coolant line between the thermostat and the first pump and another end connected to the first coolant line between the heater core and the second pump, and the heat exchanger is disposed on the first coolant bypass line and performs heat exchange between the first coolant circuit and the second coolant circuit.

### CROSS-REFERENCE TO RELATED APPLICATION

This application claims the benefit of and priority to Chinese Patent Application No. 202510417378.X, filed on Apr. 3, 2025, in the China National Intellectual Property Administration, the disclosure of which is incorporated herein in its entirety by reference.

### TECHNICAL FIELD

The present disclosure relates to a vehicle thermal management system, and more particularly, to a vehicle thermal management system configured to heat the interior of a vehicle and a battery.

### BACKGROUND

Unlike a pure electric vehicle (EV), a range-extended electric vehicle (REEV) may be additionally equipped with a range extender which generates electrical energy using a fuel source. The REEV may achieve an extended all electric range (AER) while allowing for a smaller battery capacity compared to a pure EV. In cold environments, thermal energy (heat) generated during the operation of the range extender may be used for heating the vehicle interior (cabin heating) and/or warming the battery.

However, the REEV may face thermal management challenges such as excessive heat generation by the range extender, reduced electrical efficiency, and increased noise under low-temperature conditions. In addition, the battery of the REEV may require cooling and/or heating to ensure optimal charging and discharging performance.

Accordingly, a thermal management system of the REEV is required to address the technical challenges associated with heat dissipation from the range extender and the optimization of electrical efficiency. In addition, the system must be capable of providing appropriate cooling and heating for the battery to maintain reliable operation.

The above information described in this background section is provided to assist in understanding the background of the inventive concept, and may include any technical concept which is not considered as the prior art that is already known to those having ordinary skill in the art.

### SUMMARY

The present disclosure has been made to solve the above-mentioned problems occurring in the prior art while advantages achieved by the prior art are maintained intact.

An aspect of the present disclosure provides a vehicle thermal management system configured to heat the interior of a vehicle and a battery using heat from a range extender by controlling the state of a thermostat provided in the range extender.

According to an aspect of the present disclosure, a vehicle thermal management system may include: a first coolant circuit including a range extender, a thermostat, a first pump, a heater, a heater core, and a second pump, which are connected through a first coolant line; and a second coolant circuit including a battery, a heat exchanger, and a third pump, which are connected through a second coolant line. The first coolant circuit may further include a first coolant bypass line having a first end connected to the first coolant line between the thermostat and the first pump and a second end connected to the first coolant line between the heater core and the second pump. The heat exchanger may be disposed on the first coolant bypass line and perform heat exchange between the first coolant circuit and the second coolant circuit.

In an embodiment, the first coolant circuit may further include: a second coolant bypass line having a first end connected to the thermostat and a second end connected to the first coolant line upstream of the second pump; a third coolant bypass line having a first end connected to the thermostat and a second end connected to the first coolant line upstream of the second pump; and a radiator disposed on the third coolant bypass line and configured to cool a coolant passing through the third coolant bypass line.

In an embodiment, an inlet port of the thermostat may be connected to a coolant outlet of the range extender, a first outlet port of the thermostat may be connected to the first coolant line upstream of the first end of the first coolant bypass line, a second outlet port of the thermostat may be connected to the first end of the second coolant bypass line, and a third outlet port of the thermostat may be connected to the first end of the third coolant bypass line.

In an embodiment, the vehicle thermal management system may further include an air conditioning (AC) refrigerant circuit including a compressor, a condenser, a first expansion valve, and an evaporator, which are connected through a refrigerant line. The AC refrigerant circuit may further include a refrigerant branch line having a first end connected to the refrigerant line between the condenser and the first expansion valve and a second end connected to the refrigerant line between the evaporator and the compressor.

In an embodiment, the second coolant circuit may further include: a three-way valve disposed on the second coolant line between the battery and the heat exchanger; and a fourth coolant bypass line having a first end connected to the second coolant line via the three-way valve and a second end connected to the second coolant line between the heat exchanger and the third pump. A first port of the three-way valve may be connected to the second coolant line downstream of the battery, a second port of the three-way valve may be connected to the first end of the fourth coolant bypass line, and a third port of the three-way valve may be connected to the second coolant line upstream of the heat exchanger.

In an embodiment, the vehicle thermal management system may further include: a battery cooler disposed on the fourth coolant bypass line, and disposed on the refrigerant branch line; and a second expansion valve disposed on the refrigerant branch line upstream of the battery cooler.

In an embodiment, the vehicle thermal management system may further include a controller configured to control the thermostat based on a temperature of the coolant discharged from the range extender and a temperature of the coolant flowing into the heater.

In an embodiment, when the thermostat is in a first state, the controller is configured to: operate the thermostat to close the first outlet port and the third outlet port, and to fully open the second outlet port; operate the first pump to direct the coolant discharged from the heater core to the first coolant bypass line, and to direct the coolant discharged from the first coolant bypass line to the first pump; operate the second pump to direct the coolant discharged from the second outlet port of the thermostat to the second coolant bypass line, and to direct the coolant discharged from the second coolant bypass line the second pump; operate the third pump to circulate the coolant in the second coolant circuit through the second coolant line; and operate the heater to heat the coolant in the first coolant circuit.

In an embodiment, when the thermostat is in a second state, the controller is configured to: control the thermostat to gradually open the first outlet port in response to an increase in the temperature of the coolant discharged from the range extender until it is fully opened, to fully open the second outlet port, and to close the third outlet port of the thermostat; operate the first pump and the second pump to circulate the coolant in the first coolant line, and operate the third pump to circulate the coolant in the second coolant circuit through the second coolant line; and deactivate the heater. When the thermostat is in the second state, the controller is configured to: operate the first pump and the second pump to circulate the coolant discharged from the first outlet port of the thermostat through the first pump, the heater, and the heater core in the first coolant line, to direct a portion of the coolant discharged from the heater core to the first coolant bypass line, to direct a remaining portion of the coolant discharged from the heater core to the second pump, to direct the coolant discharged from the second outlet port of the thermostat to the second coolant bypass line, and to direct the coolant discharged from the second coolant bypass line to the second pump.

In an embodiment, when the thermostat is in a third state, the controller is configured to: control the thermostat to fully open the first outlet port, to gradually close the second outlet port in response to an increase in the temperature of the coolant discharged from the range extender until it is fully closed, and to gradually open the third outlet port of the thermostat in response to an increase in the temperature of the coolant discharged from the range extender until it is fully opened; control the first pump not be operated; and operate the second pump such that a portion of the coolant discharged from the first outlet port of the thermostat is directed to the first coolant bypass line, a remaining portion of the coolant discharged from the first outlet port of the thermostat passes through the first pump, the heater, and the heater core in the first coolant line, the coolant discharged from the first coolant bypass line and the coolant discharged from the heater core flow together into the second pump through the first coolant line, the coolant discharged from the third outlet port of the thermostat flows into the radiator through the third coolant bypass line, and the coolant discharged from the radiator is directed to the second pump; the third pump may be operated such that the coolant in the second coolant circuit circulates through the second coolant line; and the heater may not be operated.

The controller may be configured to control the operation of the three-way valve based on a temperature of the battery and the temperature of the coolant discharged from the range extender to allow the coolant discharged from the battery to be directed to the fourth coolant bypass line and/or the heat exchanger. The controller may be configured to control the operation of the second expansion valve based on the temperature of the battery to allow the refrigerant flowing into the battery cooler through the refrigerant branch line to be selectively expanded.

### BRIEF DESCRIPTION OF THE DRAWINGS

The above and other objects, features and advantages of the present disclosure are more apparent from the following detailed description taken in conjunction with the accompanying drawings:

FIG. 1 is a schematic diagram illustrating a vehicle thermal management system according to an embodiment of the present disclosure;

FIG. 2 is a block diagram illustrating a vehicle thermal management system according to an embodiment of the present disclosure;

FIG. 3 is a schematic diagram illustrating a vehicle thermal management system according to an embodiment of the present disclosure operating in a first mode;

FIG. 4 is a schematic diagram illustrating a vehicle thermal management system according to an embodiment of the present disclosure operating in a second mode;

FIG. 5 is a schematic diagram illustrating a vehicle thermal management system according to an embodiment of the present disclosure operating in a third mode; and

FIG. 6 is a schematic diagram illustrating changes in the opening degrees of respective outlet ports of a thermostat in response to variations in an angle of a valve spool of the thermostat in a vehicle thermal management system according to an embodiment of the present disclosure.

### DETAILED DESCRIPTION

Hereinafter, embodiments of the present disclosure are described in detail with reference to the accompanying drawings. In the drawings, the same reference numerals are used throughout to designate the same or equivalent elements. In addition, a detailed description of well-known techniques associated with the present disclosure has been omitted in order not to unnecessarily obscure the gist of the present disclosure.

Terms such as first, second, third, A, B, and C may be used to describe the elements in the embodiments of the present disclosure. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, apparatus, and the like may separately embody or be included with a processor and a memory, such as a non-transitory computer readable media, as part of the apparatus.

The term “vehicle” used herein may generally include automobiles such as passenger cars including SUVs, buses, trucks, various commercial vehicles; ships such as various boats and vessels; and aircraft; and may further include hybrid vehicles, electric vehicles, plug-in hybrid electric vehicles, hydrogen-powered vehicles, and other alternative fuel vehicles (e.g., vehicles powered by fuel sources derived from non-petroleum energy sources).

In addition, although an exemplary process is described as being performed using a plurality of units in some embodiments of the present disclosure, it should be understood that the process may alternatively be performed using a single module or a plurality of modules. It should also be understood that the term “controller” or “controller unit” refers to a hardware apparatus including a memory and a processor. The memory may be implemented as a storage module, and the processor may be specifically configured to allow the module to perform one or more processes as described below.

The terminology used herein is for the purpose of describing particular embodiments only and is not intended to limit the scope of the present disclosure. As used herein, the singular forms “a,” “an,” and “the” are intended to include the plural forms as well, unless the context clearly indicates otherwise. It should be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, a vehicle thermal management system according to embodiments of the present disclosure are described in detail with reference to the accompanying drawings.

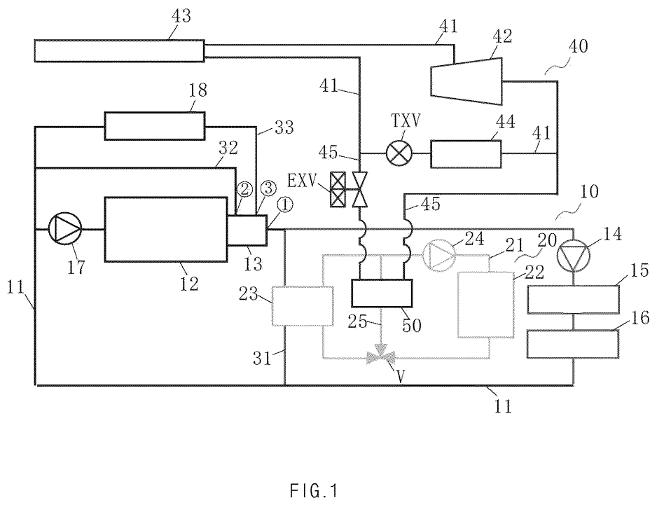

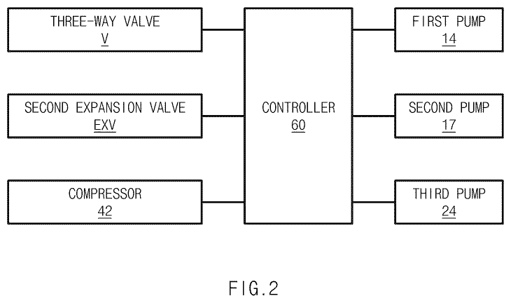

FIG. 1 is a schematic diagram illustrating a vehicle thermal management system according to an embodiment of the present disclosure, and FIG. 2 is a block diagram illustrating a vehicle thermal management system according to an embodiment of the present disclosure. Hereinafter, the vehicle thermal management system according to an embodiment of the present disclosure is described in detail with reference to FIGS. 1 and 2.

As illustrated in FIG. 1, the vehicle thermal management system according to an embodiment of the present disclosure may include a first coolant circuit 10 and a second coolant circuit 20.

According to an embodiment, the first coolant circuit 10 may include a range extender 12, a thermostat 13, a first pump 14, a heater 15, a heater core 16, and a second pump 17, which are connected via a first coolant line 11.

Specifically, the range extender 12 may be provided in a range-extended electric vehicle (REEV) to supply electricity to the electric vehicle by generating electricity through combustion of a fuel source.

The thermostat 13 may be an intelligent thermostat (ITM). The thermostat 13 may include one inlet port and three outlet ports. The inlet port of the thermostat 13 may be connected to a coolant outlet of the range extender 12, and a coolant discharged from the range extender 12 may directly flow into the thermostat 13. The outlet ports of the thermostat 13 may include a first outlet port \textcircled{1}, a second outlet port \textcircled{2}, and a third outlet port \textcircled{3}. For example, the opening degree of each outlet port of the thermostat 13 may be adjusted by controlling an actuator of the thermostat 13.

The first pump 14 may be an electric pump that circulates the coolant through the first coolant line 11.

The heater 15 may be an electric heater (e.g., PTC heater) that heats the coolant in the first coolant line 11.

The heater core 16 may be provided in a heating, ventilation, and air conditioning (HVAC) module to heat air flowing into the interior of the vehicle.

The second pump 17 may be an electric pump that circulates the coolant through the first coolant line 11.

In addition, the first coolant circuit 10 may further include a plurality of coolant bypass lines. According to an embodiment, the coolant bypass lines may include a first coolant bypass line 31, a second coolant bypass line 32, and a third coolant bypass line 33.

One end of the first coolant bypass line 31 may be connected to the first coolant line 11 between the thermostat 13 and the first pump 14, and the other end of the first coolant bypass line 31 may be connected to the first coolant line 11 between the heater core 16 and the second pump 17. In particular, one end of the first coolant bypass line 31 may be connected to the first outlet port \textcircled{1} of the thermostat 13.

One end of the second coolant bypass line 32 may be connected to the second outlet port \textcircled{2} of the thermostat 13, and the other end of the second coolant bypass line 32 may be connected to the first coolant line 11 upstream of the second pump 17.

The coolant discharged from the range extender 12 and directed to the second coolant bypass line 32 via the second outlet port \textcircled{2} of the thermostat 13 may directly return to the thermostat 13 through the second coolant bypass line 32 and the first coolant line 11. When a temperature of the coolant discharged from the range extender 12 is lower than a predetermined value, the coolant may be circulated through a loop formed by the second coolant bypass line 32 and a portion of the first coolant line 11, thereby gradually increasing a temperature of the range extender 12.

One end of the third coolant bypass line 33 may be connected to the third outlet port \textcircled{3} of the thermostat 13, and the other end of the third coolant bypass line 33 may be connected to the first coolant line 11 upstream of the second pump 17.

In an embodiment, a radiator 18 may be provided on the third coolant bypass line 33. In the radiator 18, the coolant discharged from the range extender 12 and directed to the third coolant bypass line 33 via the third outlet port \textcircled{3} of the thermostat 13 may be cooled through heat exchange with the air. The cooled coolant may return to the range extender 12 through the third coolant bypass line 33 and the first coolant line 11. When the temperature of the coolant discharged from the range extender 12 is higher than a predetermined value, the coolant may be circulated through a loop formed by the third coolant bypass line 33 and a portion of the first coolant line 11, thereby cooling the range extender 12.

According to an embodiment, the second coolant circuit 20 may include a battery 22, a three-way valve V, a heat exchanger 23, and a third pump 24, which are connected via a second coolant line 21.

In an embodiment, the battery 22 may be a high voltage battery which is a power source of the electric vehicle.

The three-way valve V may be provided on the second coolant line 21 between the battery 22 and the heat exchanger 23.

The heat exchanger 23 may be configured to perform heat exchange between the coolant in the first coolant circuit 10 and the coolant in the second coolant circuit 20.

The third pump 24 may be an electric pump that circulates the coolant through the second coolant line 21.

In addition, the second coolant circuit 20 may further include a fourth coolant bypass line 25.

One end of the fourth coolant bypass line 25 may be connected to the second coolant line 21 between the battery 22 and the heat exchanger 23 through the three-way valve V, and the other end of the fourth coolant bypass line 25 may be connected to the second coolant line 21 between the heat exchanger 23 and the third pump 24.

A first port of the three-way valve V may be connected to the second coolant line 21 downstream of the battery 22, a second port of the three-way valve V may be connected to one end of the fourth coolant bypass line 25, and a third port of the three-way valve V may be connected to the second coolant line 21 upstream of the heat exchanger 23. By operation of the three-way valve V, the coolant discharged from the battery 22 may be selectively directed to the heat exchanger 23 and/or the fourth coolant bypass line 25. Specifically, the operation of the three-way valve V may be controlled based on the temperature of the battery 22 and the temperature of the coolant discharged from the range extender 12.

In addition, the vehicle thermal management system according to an embodiment of the present disclosure may further include an air conditioning (AC) refrigerant circuit 40. The AC refrigerant circuit 40 may include a compressor 42, a condenser 43, a first expansion valve TXV, and an evaporator 44, which are connected via a refrigerant line 41.

The compressor 42 may compress a refrigerant to a high temperature and high pressure state.

The condenser 43 may condense the high-temperature and high-pressure refrigerant discharged from the compressor 42 through heat exchange.

The first expansion valve TXV may be a mechanical expansion valve that expands the condensed refrigerant.

The evaporator 44 may evaporate the expanded refrigerant discharged from the first expansion valve TXV through heat exchange.

In addition, the AC refrigerant circuit 40 may further include a refrigerant branch line 45. One end of the refrigerant branch line 45 may be connected to the refrigerant line 41 between the condenser 43 and the first expansion valve TXV, and the other end of the refrigerant branch line 45 may be connected to the refrigerant line 41 between the evaporator 44 and the compressor 42.

In addition, the vehicle thermal management system according to an embodiment of the present disclosure may further include a battery cooler 50 and a second expansion valve EXV.

The battery cooler 50 may be disposed on the fourth coolant bypass line 25, and be disposed on the refrigerant branch line 45. The battery cooler 50 may serve as a heat exchanger that performs heat exchange between the coolant and the refrigerant.

The second expansion valve EXV may be disposed on the refrigerant branch line 45 upstream of the battery cooler 50. The second expansion valve EXV may be an electronic expansion valve, and selectively expand the refrigerant that flows into the battery cooler 50.

The coolant, having increased in temperature while passing through the battery 22, may be directed to the fourth coolant bypass line 25 via the three-way valve V. When the second expansion valve EXV expands the refrigerant, the coolant passing through the fourth coolant bypass line 25 may exchange heat with the expanded refrigerant passing through the refrigerant branch line 45 in the battery cooler 50. The coolant may be cooled, and the cooled coolant may be used to cool the battery 22. Accordingly, the battery 22 may be cooled using the refrigerant in the AC refrigerant circuit 40.

In addition, the vehicle thermal management system according to an embodiment of the present disclosure may further include a controller 60. The controller 60 may be a controller of a battery management system (BMS) or an air conditioning (AC) system of the vehicle, or may be an additional controller separately provided.

The controller 60 may control the state of the thermostat 13 based on the temperature of the coolant discharged from the range extender 12 and the temperature of the coolant flowing into the heater 15. Specifically, the controller 60 may adjust an angle of a valve spool of the thermostat 13 in response to the temperature of the coolant discharged from the range extender 12 and the temperature of the coolant flowing into the heater 15, thereby changing the opening degrees of the first outlet port \textcircled{1}, the second outlet port \textcircled{2}, and the third outlet port \textcircled{3} of the thermostat 13. Here, when the opening degree is 0%, the corresponding outlet port may be in a closed state, and when the opening degree is 100%, the corresponding outlet port may be in a fully open state.

In addition, the controller 60 may control the operation of the three-way valve V and the second expansion valve EXV based on the temperature of the battery 22 and the temperature of the coolant discharged from the range extender 12. Specifically, the controller 60 may control the operation of the three-way valve V based on the temperature of the battery 22 and the temperature of the coolant discharged from the range extender 12 to allow the coolant discharged from the battery 22 to be directed to the fourth coolant bypass line 25 and/or the heat exchanger 23. The controller 60 may control the operation of the second expansion valve EXV based on the temperature of the battery 22 to allow the refrigerant flowing into the battery cooler 50 through the refrigerant branch line 45 to be selectively expanded.

Furthermore, the controller 60 may control the operation of the first pump 14, the second pump 17, the third pump 24, and the compressor 42.

The vehicle thermal management system according to an embodiment of the present disclosure may further include a cooling circuit for cooling a turbocharger, a cooling circuit for cooling electric components (e.g., a motor), and the like. Here, a detailed description of these circuits is omitted so as not to unnecessarily obscure the gist of the present disclosure.

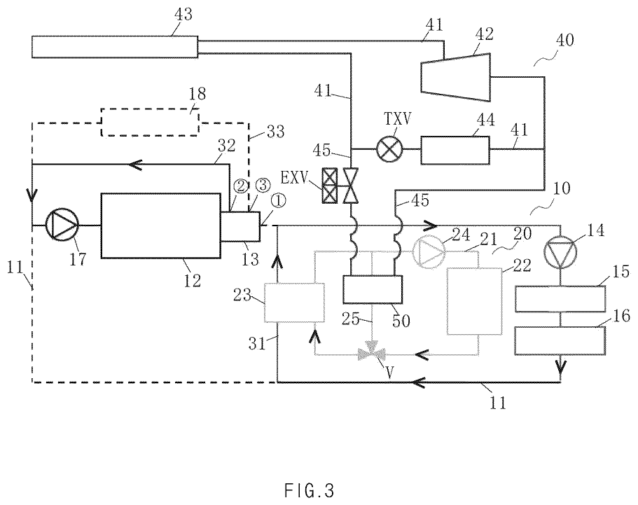

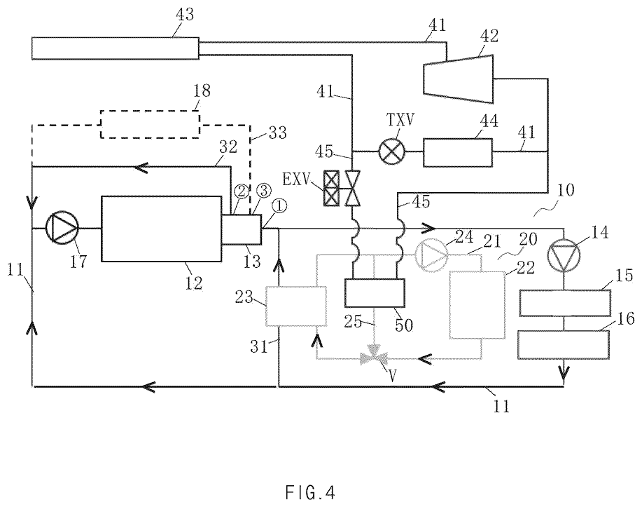

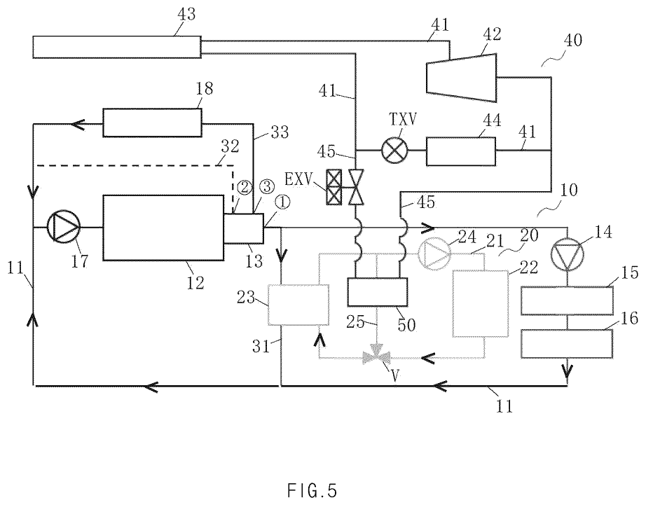

FIG. 3 is a schematic diagram illustrating a vehicle thermal management system according to an embodiment of the present disclosure operating in a first mode; FIG. 4 is a schematic diagram illustrating a vehicle thermal management system according to an embodiment of the present disclosure operating in a second mode; and FIG. 5 is a schematic diagram illustrating a vehicle thermal management system according to an embodiment of the present disclosure operating in a third mode. Hereinafter, the first to third modes of the vehicle thermal management system according to an embodiment of the present disclosure are described in detail with reference to FIGS. 3 to 5.

As illustrated in FIG. 3, the first mode refers to a mode in which the interior of the vehicle and the battery 22 are heated using the heater 15. In the first mode, the thermostat 13 may be in a first state. In the first state, the controller 60 may control the thermostat 13 in such a manner that the first outlet port \textcircled{1} and the third outlet port \textcircled{3} are closed, and the second outlet port \textcircled{2} is fully opened.

In addition, the controller 60 may control the second pump 17 to operate so that the coolant discharged from the second outlet port \textcircled{2} of the thermostat 13 may flow into the second coolant bypass line 32, and the coolant discharged from the second coolant bypass line 32 may flow into the second pump 17. Specifically, all of the coolant flowing from the coolant outlet of the range extender 12 into the thermostat 13 may be discharged through the second outlet port \textcircled{2} of the thermostat 13. The coolant discharged from the second outlet port \textcircled{2} of the thermostat 13 may be directed to the second coolant bypass line 32, and the coolant passing through the second coolant bypass line 32 may be directed to the first coolant line 11 upstream of the second pump 17 and then be directed to the second pump 17. The coolant discharged from the second pump 17 may return to the range extender 12. The coolant may absorb heat generated by the operation of the range extender 12, thereby increasing its temperature. Accordingly, as the coolant circulates through the loop formed by the second coolant bypass line 32 and a portion of the first coolant line 11, the temperature of the coolant may be gradually increased.

In the first mode, the heat generated by the operation of the range extender 12 may not be sufficient for use in the heating of the heater core 16 and the heating of the battery 22. Accordingly, the controller 60 may control the operation of the heater 15 to provide heat for heating the heater core 16 and the battery 22.

Furthermore, the controller 60 may control the operation of the first pump 14 to allow the coolant discharged from the heater core 16 to be directed to the first coolant bypass line 31, and allow the coolant discharged from the first coolant bypass line 31 to flow into the first pump 14.

Specifically, the coolant discharged from the first pump 14 may flow through the first coolant line 11, passing through the heater 15 and the heater core 16. While passing through the heater 15, the coolant may be heated. The heated coolant may heat the interior of the vehicle (cabin heating) while passing through the heater core 16. The coolant discharged from the heater core 16 may be directed to the first coolant bypass line 31, instead of flowing into the first coolant line 11 upstream of the second pump 17.

The first outlet port \textcircled{1} and the third outlet port \textcircled{3} of the thermostat 13 are closed, and the second outlet port \textcircled{2} of the thermostat 13 is fully opened. Thus, the second coolant bypass line 32 and a portion of the first coolant line 11 may form an independent loop, while the first coolant bypass line 31 and a portion of the first coolant line 11 may form another independent loop.

In addition, the controller 60 may control the third pump 24 to operate so that the coolant in the second coolant circuit 20 may circulate through the second coolant line 21.

Specifically, the coolant discharged from the battery 22 may flow through the second coolant line 21, passing through the three-way valve V and the heat exchanger 23. While passing through the heat exchanger 23, the coolant in the second coolant line 21 may exchange heat with the coolant in the first coolant bypass line 31, causing the temperature of the coolant in the second coolant line 21 to increase. The coolant, having increased in temperature and discharged from the heat exchanger 23, may flow into the third pump 24 and the battery 22, thereby warming the battery 22.

In the first mode, in the independent loop formed by the second coolant bypass line 32 and a portion of the first coolant line 11, the coolant may absorb heat from the range extender 12, causing the temperature of the coolant to increase. In the independent loop formed by the first coolant bypass line 31 and a portion of the first coolant line 11, the coolant may be heated by the heater 15, thereby heating the interior of the vehicle via the heater core 16. In the second coolant circuit 20, the heat from the coolant heated by the heater 15 may be absorbed through the heat exchanger 23, thereby heating the battery 22.

As illustrated in FIG. 4, the second mode refers to a mode in which the interior of the vehicle and the battery 22 are heated using heat from the range extender 12. In the second mode, the thermostat 13 may be in a second state. In the second state, the controller 60 may control the thermostat 13 in such a manner that the first outlet port \textcircled{1} is gradually opened in response to an increase in the temperature of the coolant discharged from the range extender 12 until it is fully opened; the second outlet port \textcircled{2} is fully opened; and the third outlet port \textcircled{3} is closed. A portion of the coolant flowing from the coolant outlet of the range extender 12 into the thermostat 13 may be directed to the first coolant line 11 upstream of the first pump 14 via the first outlet port \textcircled{1} of the thermostat 13, and a remaining portion of the coolant may be directed to the second coolant bypass line 32 via the second outlet port \textcircled{2} of the thermostat 13.

In addition, the controller 60 may control the first pump 14 and the second pump 17 to operate so that the coolant discharged from the first outlet port \textcircled{1} of the thermostat 13 may pass through the first pump 14, the heater 15, and the heater core 16 in the first coolant line 11; a portion of the coolant discharged from the heater core 16 may be directed to the first coolant bypass line 31; a remaining portion of the coolant discharged from the heater core 16 may be directed to the second pump 17; the coolant discharged from the second outlet port \textcircled{2} of the thermostat 13 may be directed to the second coolant bypass line 32; and the coolant discharged from the second coolant bypass line 32 may be directed to the second pump 17.

Specifically, a portion of the coolant flowing from the coolant outlet of the range extender 12 into the thermostat 13 may be discharged through the first outlet port \textcircled{1} of the thermostat 13. The coolant discharged through the first outlet port \textcircled{1} of the thermostat 13 may flow through the first coolant line 11, sequentially passing through the first pump 14, the heater 15, and the heater core 16. At this time, the heater 15 may not be operated. Although the heater 15 is not operated, the temperature of the range extender 12 may increase so that the temperature of the coolant discharged from the range extender 12 may be sufficient to heat the heater core 16 and the battery 22. Accordingly, the coolant may heat the interior of the vehicle (cabin heating) while passing through the heater core 16. A portion of the coolant discharged from the heater core 16 may be directed to the first coolant bypass line 31, and a remaining portion of the coolant discharged from the heater core 16 may be directed to the second pump 17 through the first coolant line 11.

Most of the coolant discharged from the heater core 16 may be directed to the first coolant bypass line 31. The coolant discharged from the first coolant bypass line 31 may be directed to the first coolant line 11 upstream of the first pump 14 and then flow into the first pump 14. A small portion of the coolant discharged from the heater core 16 may be directed to the second pump 17 through the first coolant line 11, and the coolant discharged from the second pump 17 may return to the range extender 12.

Meanwhile, a remaining portion of the coolant flowing from the coolant outlet of the range extender 12 into the thermostat 13 may be discharged through the second outlet port \textcircled{2} of the thermostat 13. The coolant discharged from the second outlet port \textcircled{2} of the thermostat 13 may flow into the second coolant bypass line 32, and the coolant passing through the second coolant bypass line 32 may be directed to the first coolant line 11 upstream of the second pump 17 and then be directed to the second pump. The coolant discharged from the second pump 17 may return to the range extender 12.

In addition, the controller 60 may control the third pump 24 to operate so that the coolant in the second coolant circuit 20 may circulate through the second coolant line 21.

Specifically, the coolant discharged from the battery 22 may flow through the second coolant line 21, passing through the three-way valve V and the heat exchanger 23. While passing through the heat exchanger 23, the coolant in the second coolant line 21 may exchange heat with the coolant in the first coolant bypass line 31, causing the temperature of the coolant in the second coolant line 21 to increase. The coolant, having increased in temperature and discharged from the heat exchanger 23, may flow into the third pump 24 and the battery 22, thereby warming the battery 22.

In the second mode, in the loop formed by the second coolant bypass line 32 and a portion of the first coolant line 11, the coolant may absorb heat from the range extender 12, causing the temperature of the coolant to increase. In the loop formed by the first coolant bypass line 31 and a portion of the first coolant line 11, the heat from the range extender 12 may be used to heat the interior of the vehicle through the heater core 16. In the second coolant circuit 20, the heat from the coolant heated by the range extender 12 may be absorbed through the heat exchanger 23, thereby heating the battery 22.

As illustrated in FIG. 5, the third mode refers to a mode in which the interior of the vehicle and the battery 22 are heated using heat from the range extender 12, and the range extender 12 is cooled. In the third mode, the thermostat 13 may be in a third state. In the third state, the controller 60 may control the thermostat 13 in such a manner that the first outlet port \textcircled{1} is fully opened; the second outlet port \textcircled{2} is gradually closed in response to an increase in the temperature of the coolant discharged from the range extender 12 until it is fully closed; and the third outlet port \textcircled{3} is gradually opened in response to an increase in the temperature of the coolant discharged from the range extender 12 until it is fully opened. A portion of the coolant flowing from the coolant outlet of the range extender 12 into the thermostat 13 may be directed to the first coolant bypass line 31 via the first outlet port \textcircled{1} of the thermostat 13, and a remaining portion of the coolant may be directed to the third coolant bypass line 33 via the third outlet port \textcircled{3} of the thermostat 13.

In addition, the controller 60 may control the first pump 14 to be inactive and control the second pump 17 to operate so that a portion of the coolant discharged from the first outlet port \textcircled{1} of the thermostat 13 may be directed to the first coolant bypass line 31; a remaining portion of the coolant discharged from the first outlet port \textcircled{1} of the thermostat 13 may pass through the first pump 14, the heater 15, and the heater core 16 in the first coolant line 11; the coolant discharged from the first coolant bypass line 31 and the coolant discharged from the heater core 16 may flow together into the second pump 17 through the first coolant line 11; the coolant discharged from the third outlet port \textcircled{3} of the thermostat 13 may flow into the radiator 18 through the third coolant bypass line 33; and the coolant discharged from the radiator 18 may be directed to the second pump 17.

Specifically, a portion of the coolant flowing from the coolant outlet of the range extender 12 into the thermostat 13 may be discharged through the first outlet port \textcircled{1} of the thermostat 13. Since the first pump 14 is not operated, a portion of the coolant discharged from the first outlet port \textcircled{1} of the thermostat 13 may be directed to the first coolant bypass line 31. A remaining portion of the coolant discharged from the first outlet port \textcircled{1} of the thermostat 13 may flow through the first coolant line 11, sequentially passing through the first pump 14, the heater 15, and the heater core 16. At this time, the heater 15 may not be operated. Although the heater 15 is not operated, the temperature of the coolant discharged from the range extender 12 may be sufficient to heat the heater core 16 and the battery 22. Accordingly, the coolant may heat the interior of the vehicle (cabin heating) while passing through the heater core 16.

The coolant discharged from the first coolant bypass line 31 and the coolant discharged from the heater core 16 may merge at the other end of the first coolant bypass line 31, flow together into the first coolant line 11 upstream of the second pump 17 and then be directed to the second pump 17. The coolant discharged from the second pump 17 may return to the range extender 12.

Meanwhile, a remaining portion of the coolant flowing from the coolant outlet of the range extender 12 into the thermostat 13 may be discharged through the third outlet port \textcircled{3} of the thermostat 13. The coolant discharged from the third outlet port \textcircled{3} of the thermostat 13 may be directed to the third coolant bypass line 33 and flow into the radiator 18 provided on the third coolant bypass line 33. In the radiator 18, the high-temperature coolant discharged from the range extender 12 may be cooled by heat exchange with the air. The cooled coolant may return to the range extender 12 through the third coolant bypass line 33 and the first coolant line 11, thereby cooling the range extender 12. The coolant passing through the third coolant bypass line 33 may be directed to the first coolant line 11 upstream of the second pump 17 and then be directed to the second pump 17. The coolant discharged from the second pump 17 may return to the range extender 12.

In addition, the controller 60 may control the third pump 24 to operate so that the coolant in the second coolant circuit 20 may circulate through the second coolant line 21.

Specifically, the coolant discharged from the battery 22 may flow through the second coolant line 21, passing through the three-way valve V and the heat exchanger 23. While passing through the heat exchanger 23, the coolant in the second coolant line 21 may exchange heat with the coolant in the first coolant bypass line 31, causing the temperature of the coolant in the second coolant line 21 to increase. The coolant, having increased in temperature and discharged from the heat exchanger 23, may flow into the third pump 24 and the battery 22, thereby warming the battery 22.

In the third mode, in the loop formed by the third coolant bypass line 33 and a portion of the first coolant line 11, the coolant may be cooled in the radiator 18 through heat exchange with the air, thereby cooling the range extender 12. In the loop formed by the first coolant bypass line 31 and the portion of the first coolant line 11, the heat from the range extender 12 may be used to heat the interior of the vehicle via the heater core 16. In the second coolant circuit 20, the heat from the coolant heated by the range extender 12 may be absorbed through the heat exchanger 23, thereby heating the battery 22.

In particular, in the third mode in which the temperature of the range extender 12 is high, in order to prevent the temperature of the coolant heated by the heat of the range extender 12 from becoming excessively high (e.g., exceeding an optimal operating temperature range of the battery 22), the controller 60 may control the operation of the three-way valve V to allow at least a portion of the coolant discharged from the battery 22 to be directed to the fourth coolant bypass line 25, instead of directing all of the coolant into the heat exchanger 23.

Specifically, the controller 60 may control the operation of the three-way valve V based on the temperature of the battery 22 and the temperature of the coolant discharged from the range extender 12 to allow the second port connected to the fourth coolant bypass line 25 to be opened or partially opened, and allow the third port connected to the second coolant line 21 upstream of the heat exchanger 23 to be closed or partially closed.

In addition, when the cooling of the battery 22 is required, the refrigerant in the AC refrigerant circuit 40 may be used to cool the battery 22. The controller 60 may control the operations of the three-way valve V and the second expansion valve EXV based on the temperature of the battery 22.

Specifically, the controller 60 may control the operation of the three-way valve V to allow the second port connected to the fourth coolant bypass line 25 to be opened, and allow the third port connected to the second coolant line 21 upstream of the heat exchanger 23 to be closed. In addition, the controller 60 may control the operation of the second expansion valve EXV to allow the refrigerant flowing into the battery cooler 50 through the refrigerant branch line 45 to be expanded. Accordingly, the coolant directed to the fourth coolant bypass line 25 via the three-way valve V may exchange heat with the expanded refrigerant directed to the refrigerant branch line 45 in the battery cooler 50. The coolant may be cooled, and the cooled coolant may be used to cool the battery 22.

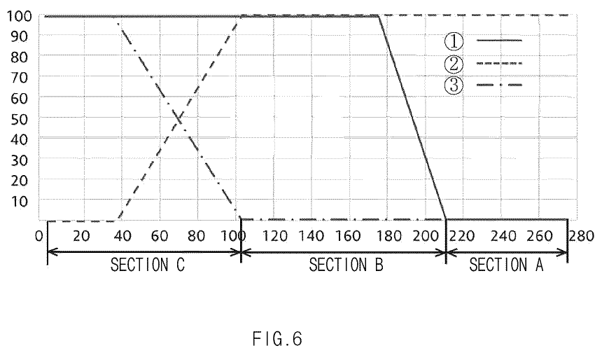

FIG. 6 is a schematic diagram illustrating changes in the opening degrees of respective outlet ports of a thermostat in response to variations in an angle of a valve spool of the thermostat in a vehicle thermal management system according to an embodiment of the present disclosure.

In FIG. 6, a horizontal axis represents the angle (in degrees) of the valve spool of the thermostat 13, and a vertical axis represents the opening degrees (in percentage) of the first outlet port \textcircled{1}, the second outlet port \textcircled{2}, and the third outlet port \textcircled{3} of the thermostat 13. Three graphs indicate changes in the opening degrees of the first outlet port \textcircled{1}, the second outlet port \textcircled{2}, and the third outlet port \textcircled{3} in response to variations in the valve spool angle, respectively. Here, a solid line represents changes in the opening degree of the first outlet port \textcircled{1}, a dashed line represents changes in the opening degree of the second outlet port \textcircled{2}, and a dash-dotted line represents changes in the opening degree of the third outlet port \textcircled{3}.

As illustrated in FIG. 6, in section A (i.e., in a range from approximately 210 degrees to approximately 275 degrees), the thermostat 13 may be in the first state. In the first state of the thermostat 13, the first outlet port \textcircled{1} and the third outlet port \textcircled{3} may be closed, and the second outlet port \textcircled{2} may be fully opened.

In section B (i.e., in a range from approximately 105 degrees to approximately 210 degrees), the thermostat 13 may be in the second state. In the second state of the thermostat 13, the first outlet port \textcircled{1} may be gradually opened in response to an increase in the temperature of the coolant discharged from the range extender 12 until it is fully opened; the second outlet port \textcircled{2} may be fully opened; and the third outlet port \textcircled{3} may be closed.

In section C (i.e., in a range from approximately 5 degrees to approximately 105 degrees), the thermostat 13 may be in the third state. In the third state of the thermostat 13, the first outlet port \textcircled{1} may be fully opened; the second outlet port \textcircled{2} may be gradually closed in response to an increase in the temperature of the coolant discharged from the range extender 12 until it is fully closed; and the third outlet port \textcircled{3} may be gradually opened in response to an increase in the temperature of the coolant discharged from the range extender 12 until it is fully opened.

The vehicle thermal management system according to embodiments of the present disclosure may be applicable to an electric vehicle, especially to a range-extended electric vehicle (REEV). The vehicle thermal management system may be configured to heat the interior of the vehicle and the battery using the heat from the range extender by controlling the state of the thermostat disposed in the range extender.

The vehicle thermal management system according to an embodiment of the present disclosure may be configured to cool the range extender by controlling the state of the thermostat disposed in the range extender.

The vehicle thermal management system according to an embodiment of the present disclosure may be configured to cool the battery using the refrigerant in the AC refrigerant circuit.

Hereinabove, although the present disclosure has been described with reference to embodiments and the accompanying drawings, the present disclosure is not limited thereto, but may be variously modified and altered by those having ordinary skill in the art to which the present disclosure pertains without departing from the spirit and scope of the present disclosure claimed in the following claims.

What is claimed is:

1. A vehicle thermal management system, comprising:
a first coolant circuit including a range extender, a thermostat, a first pump, a heater, a heater core, and a second pump, which are connected via a first coolant line; and
a second coolant circuit including a battery, a heat exchanger, and a third pump, which are connected via a second coolant line,
wherein the first coolant circuit further includes a first coolant bypass line including:
a first end connected to the first coolant line between the thermostat and the first pump, and
a second end connected to the first coolant line between the heater core and the second pump, and
wherein the heat exchanger is disposed on the first coolant bypass line and configured to perform heat exchange between the first coolant circuit and the second coolant circuit.

2. The vehicle thermal management system according to claim 1, wherein the first coolant circuit further includes:
a second coolant bypass line having a first end connected to the thermostat and a second end connected to the first coolant line upstream of the second pump;
a third coolant bypass line having a first end connected to the thermostat and a second end connected to the first coolant line upstream of the second pump; and
a radiator disposed on the third coolant bypass line and configured to cool a coolant passing through the third coolant bypass line.

3. The vehicle thermal management system according to claim 2, wherein:
an inlet port of the thermostat is connected to a coolant outlet of the range extender,
a first outlet port of the thermostat is connected to the first coolant line upstream of the first end of the first coolant bypass line,
a second outlet port of the thermostat is connected to the first end of the second coolant bypass line, and
a third outlet port of the thermostat is connected to the first end of the third coolant bypass line.

4. The vehicle thermal management system according to claim 3, further comprising an air conditioning (AC) refrigerant circuit including a compressor, a condenser, a first expansion valve, and an evaporator, which are connected via a refrigerant line,
wherein the AC refrigerant circuit further includes a refrigerant branch line having a first end connected to the refrigerant line between the condenser and the first expansion valve and a second end connected to the refrigerant line between the evaporator and the compressor.

5. The vehicle thermal management system according to claim 4, wherein the second coolant circuit further includes:
a three-way valve disposed on the second coolant line between the battery and the heat exchanger; and
a fourth coolant bypass line having a first end connected to the second coolant line via the three-way valve and a second end connected to the second coolant line between the heat exchanger and the third pump,
a first port of the three-way valve is connected to the second coolant line downstream of the battery,
a second port of the three-way valve is connected to the first end of the fourth coolant bypass line, and
a third port of the three-way valve is connected to the second coolant line upstream of the heat exchanger.

6. The vehicle thermal management system according to claim 5, further comprising:
a battery cooler disposed on the fourth coolant bypass line, and disposed on the refrigerant branch line; and
a second expansion valve disposed on the refrigerant branch line upstream of the battery cooler.

7. The vehicle thermal management system according to claim 6, further comprising a controller configured to control the thermostat based on a temperature of the coolant discharged from the range extender and a temperature of the coolant flowing into the heater.

8. The vehicle thermal management system according to claim 7, wherein, when the thermostat is in a first state, the controller is configured to:
control the thermostat to close the first outlet port and the third outlet port and to fully open the second outlet port;
operate the first pump to direct the coolant discharged from the heater core to the first coolant bypass line, and to direct the coolant discharged from the first coolant bypass line to the first pump; and
operate the second pump to direct the coolant discharged from the second outlet port of the thermostat to the second coolant bypass line, and to direct the coolant discharged from the second coolant bypass line to the second pump.

9. The vehicle thermal management system according to claim 8, wherein the controller is further configured to:
operate the third pump to circulate the coolant in the second coolant circuit through the second coolant line; and
operate the heater to heat the coolant in the first coolant circuit.

10. The vehicle thermal management system according to claim 7, wherein, when the thermostat is in a second state, the controller is configured to:
control the thermostat to gradually open the first outlet port in response to an increase in the temperature of the coolant discharged from the range extender until it is fully opened, to fully open the second outlet port, and to close the third outlet port;
operate the first pump and the second pump to circulate the coolant in the first coolant line, and operate the third pump to circulate the coolant in the second coolant circuit through the second coolant line; and
deactivate the heater.

11. The vehicle thermal management system according to claim 10, wherein the controller is further configured to:
operate the first pump and the second pump to circulate the coolant discharged from the first outlet port of the thermostat through the first pump, the heater, and the heater core in the first coolant line, to direct a portion of the coolant discharged from the heater core to the first coolant bypass line, to direct a remaining portion of the coolant discharged from the heater core to the second pump, to direct the coolant discharged from the second outlet port of the thermostat to the second coolant bypass line, and to direct the coolant discharged from the second coolant bypass line to the second pump.

12. The vehicle thermal management system according to claim 7, wherein, when the thermostat is in a third state, the controller is configured to:
control the thermostat to fully open the first outlet port, to gradually close the second outlet port in response to an increase in the temperature of the coolant discharged from the range extender until it is fully closed, and to gradually open the third outlet port in response to an increase in the temperature of the coolant discharged from the range extender until it is fully opened;
control the first pump and the second pump such that the first pump is not operated, and the second pump is operated;
operate the third pump to circulate the coolant in the second coolant circuit through the second coolant line; and
deactivate the heater.

13. The vehicle thermal management system according to claim 12, wherein the controller is configured to deactivate the first pump and operate the second pump to direct a portion of the coolant discharged from the first outlet port of the thermostat to the first coolant bypass line, to circulate a remaining portion of the coolant discharged from the first outlet port of the thermostat through the first pump, the heater, and the heater core in the first coolant line, to cause the coolant discharged from the first coolant bypass line and the coolant discharged from the heater core to flow together into the second pump through the first coolant line, to direct the coolant discharged from the third outlet port of the thermostat to the radiator through the third coolant bypass line, and to direct the coolant discharged from the radiator to the second pump.

14. The vehicle thermal management system according to claim 7, wherein the controller is configured to control an operation of the three-way valve based on a temperature of the battery and the temperature of the coolant discharged from the range extender to allow the coolant discharged from the battery to be directed to at least one of the fourth coolant bypass line or the heat exchanger, and
the controller is configured to control an operation of the second expansion valve based on the temperature of the battery to allow the refrigerant flowing into the battery cooler through the refrigerant branch line to be selectively expanded.
